(19) United States
(12) Patent Application Publication
(10) Pub. No.: US 2018/0159950 A1
(43) Pub. Date: Jun. 7, 2018

(54) METHOD FOR CREATING CACHE TO E-COMMERCE APPLICATION IN MOBILE DEVICE

(71) Applicant: MUTHUKRISHNAN GOVINDARAJ, PARLIN, NJ (US)

(72) Inventor: MUTHUKRISHNAN GOVINDARAJ, PARLIN, NJ (US)

(21) Appl. No.: 15/370,039

(22) Filed: Dec. 6, 2016

(51) Int. Cl. H04L 29/08; G06Q 30/06

(52) U.S. Cl. CPC H04L 67/2857; H04L 67/02; G06Q 30/0601

(57) ABSTRACT

A method for creating cache to e-commerce application in mobile device that comprising an engine that provides cache storage feature to user's mobile device. The engine communicates with merchant's website by means of bundle of application programming interface functions that are attached to engine. The said engine creates a cache of required product information and other related information thus making the application function faster, by retrieving the data from both the local data storage of device and from merchant's website via application programming interface. The present invention has data consists of all the e-commerce product's information such as stock inventory information, price, image paths, relative products, description, product specification information etc. The present invention makes the mobile commerce application function faster by referring the product data stored in device cache database and refreshing intelligently as per user traversing between product ranges in mobile device.

### FIELD OF INVENTION

The present invention relates to mobile device utilizing cache memory. Specifically the present invention relates to a method for creating cache to e-commerce application in mobile device.

### BACKGROUND OF THE INVENTION

The complexity of mobile applications has been increased, more mobile applications use application platforms to provide scalable functionality for their mobile applications. Application platforms may provide remote functionality, remote storage, or the like, that mobile applications may interact with over a network. In some cases, networks linking mobile applications and application platforms may be slow and/or unreliable. As a result, mobile application performance may suffer if interactions between mobile applications and application platforms increase in number and complexity.

The problem with the existing methods are such that when the mobile application user request information about product or view the product catalog list, it will fetch the product information every-time from the server via an application programming interface (API) and it consumes the server resources, wait time for the user for processing and presenting the content to mobile application.

The current methods doesn't have real-time connection between server and the ecommerce mobile application, they require a separate application or code to be deployed in the cloud code. Moreover the existing method does not allow mobile devices to cache application information. There are dynamic data that needs to be improved to a mobile application from the website backend like stock information and price (includes offers, tax and reward).

Various e-commerce mobile applications methods have been devised in art; some of the measures are as follows:

U.S. Pat. No. 8,739,282 discloses mobile application development in a cloud-based architecture, and more particularly, but not exclusively, to deploying mobile application code in a cloud-based environment.

U.S. Pat. No. 9,117,239 relates to tracking ecommerce data, and more particularly, to monitoring and recommending relevant products based on ecommerce data.

US patent Application 20140279533 discloses a real-time application programming interface for merchant enrollment and underwriting, wherein the said process includes receiving from a first computing device and a request for applying for the merchant financial account for a merchant applicant.

Another US patent Application 20140025890 relates to methods and structure for improved flexibility in managing cache memory in a storage controller of a computing device on which multiple virtual machines are operating in a VM computing environment.

Yet another US patent application 20140244447 discloses multimedia commerce delivery to end-users, and more specifically to delivery of a branded commerce environment to end-user devices, such as a smart TV.

A know prior art discloses a system and method for scheduling the harvesting of information associated with one or more end users from one or more information providers.

The present invention overcomes the inadequacies of the prior art by a method for creating cache to e-commerce application in mobile device.

### OBJECTS OF THE INVENTION

One or more of the problems of the conventional prior art may be overcome by various embodiments of the present invention.

Accordingly, the primary object of the present invention is to provide a method for creating cache to e-commerce applications in mobile device.

One object of the present invention is to provide an engine to create a cache in mobile devices.

It is one object of the present invention, wherein the said engine creates a cache of product information and other related information for making application faster.

It is another object of the present invention, wherein the said engine updates the database by means of application programming interface.

It is one another object of the present invention, wherein the said engine communicates with device and merchant's website by means of one or more application programming.

It is yet another object of the present invention, wherein the said data is retrieved from information stored data in user's mobile device and also from merchant's e-commerce website.

It is even another object of the present invention, wherein the said data consists of updated information's such as stock information, price and new products.

It is one object of the present invention, wherein the said application doesn't required special maintenance as it is updated timely.

It is one another object of the present invention, wherein the said invention functions with user's mobile device internal cache engine that fetches information from merchant website's catalog information system depending on the user traversing between two boundaries.

### SUMMARY OF THE INVENTION

According to the basic aspect of the present invention there is provided a method for creating cache to e-commerce application in mobile device comprising: providing a cache in mobile devices by means of engine, communicating with merchant website and mobile device database by means of application programming interface, creating a cache of particular product information, retrieving data from device database and from merchant website backend, storing index of product information, maintaining the track of traverse process using the said index, and updating the required information periodically using merchant's website.

It is one aspect of the present invention, wherein retrieving information further comprises data of particular category, whereas the said data comprises information's such as product addition, stock information and price list.

It is another aspect of the present invention, wherein storing of data of said category in user device for further use by the said engine.

It is yet another aspect of the present invention, wherein importing data to the said application from the merchant website backend.

It is even another aspect of the present invention, wherein refreshing the cache timely to meet the prefixed threshold range.

It is one aspect of the present invention, wherein a cache storing application comprising: an engine to create cache in user device for e-commerce applications.

It is another aspect of the present invention, wherein the said engine comprises one or more application programming interface.

It is even another aspect of the present invention, wherein the said engine communicates with merchant website by means of application programming interface.

It is one another aspect of the present invention, wherein the said engine creates a cache mechanism through application programming interface calls.

It is one aspect of the present invention, wherein the said engine functions with user's mobile device internal cache engine that fetches information from merchant website's catalog information system depending on the user traversing between two boundaries.

It is one aspect of the present invention, wherein no specific maintenance is required for the said application as the data in cache is updated periodically.

It is one another aspect of the present invention, wherein the said engine induces the said application perform faster by storing the required data in device database.

### BRIEF DESCRIPTION OF DRAWINGS

The above set forth and other features of the invention are made more apparent in the ensuring detailed description of the invention, when read in conjunction with the accompanying drawing, wherein:

FIG. 1 illustrates the flow chart of the method of working of said application in mobile phone, according to the present invention.

### DETAILED DESCRIPTION OF INVENTION WITH REFERENCE TO THE ACCOMPANYING DRAWINGS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices.

The present invention discloses an engine to create cache in mobile device for e-commerce applications. The said engine contains one or more application programming interface that connects merchant's website with mobile device database. The said engine creates a cache of product information and other related information for making the e-commerce application faster.

In one embodiment of the present invention, storage engine will gather the connection details from merchant and connects the merchant website and mobile applications via Application Programming Interface (API) in real-time and there are no code required to submit in cloud code.

In another embodiment of the present invention, the said e-commerce application assist the said mobile application user to view complete catalog information in anye-commerce mobile applications faster with less buffering time. The said application provides product information to mobile application user from cache storage. The said application refreshes with new product information when nearing the threshold range (both upper bound and lower bound of the product ranges during traversing).

In one preferred design of the present invention the said cache storage engine serves the product inventory or stock information to the user in real-time via interactive API to merchant website. This cache storage engine makes the mobile e-commerce application to perform faster by storing data in the device database and frequently update the particular fields or data that are changing dynamically.

In another preferred design of the present invention, the said caching engine creates a cache in the desired device. When particular category of products is opened for the first time, the engine retrieves all information about product like name, price, variants, images, stock or inventory etc., and stores in the cache storage. When the same category is opened for second time, the data is retrieved from cache except little information like stock or inventory and the database is updated if there are any changes occurred in the backend.

In yet another preferred design of the present invention, the said engine communicates with the merchant website and mobile application through web APIs and creates a caching mechanism through API calls. When a specific category is opened in the mobile application, the data is directly fetched from the local database making the application function faster.

In the present invention, the data stored in device is precise and does not require a separate maintenance for the said mobile application because the data in the cache is updated periodically to the changes occur on the database such as addition of new product.

This invention is further described through the following working mode of the said engine of the mobile application, which is only illustrative in the nature and should not be construed to limit the scope of invention.

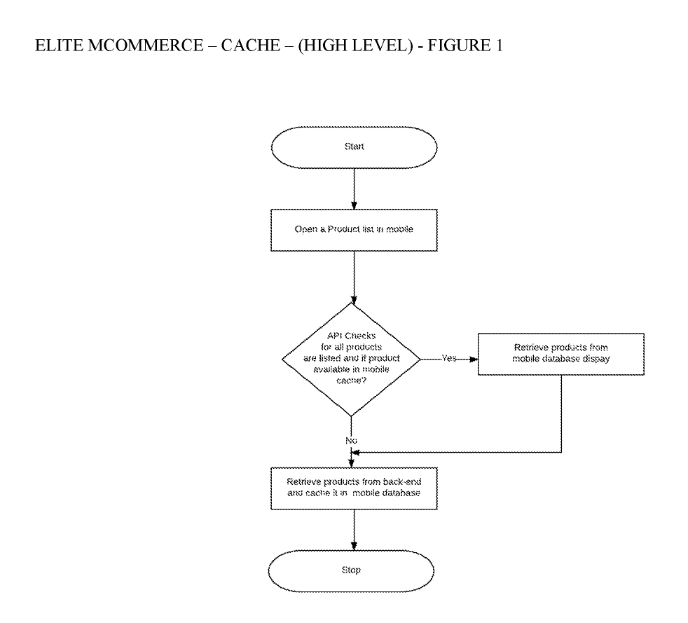

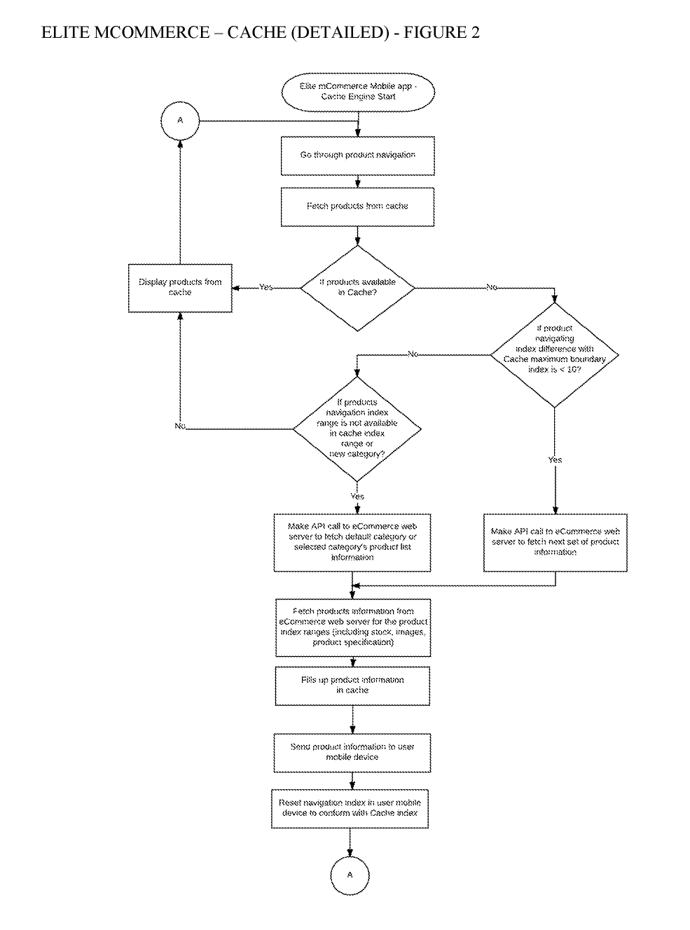

With reference to FIG. 1, in the present invention when a user browses the product catalog in the said e-commerce mobile application for first time the said application will fetch the product catalog information and stores into the cache storage engine, wherein the user browse the products one by one in the list, the mobile application serves the product information to the mobile application user from the cache storage.

In one feature of the present invention, if the user's traversing boundary reaches the last 10^{th} product information, the cache storage engine automatically refresh the user's mobile device cache storage setting with new set of product information and present the information from cache.

When the user views the product information that are displayed from cache storage, it will check the real-time information of the product like stock or inventory from the back end web server via an API call and all other information are presented from cache.

The said application serves the product information from cache intelligently based on the frequent hit or reference by the application and also refreshes the cache with new product based on traversing.

The said engine gathers the connection details from merchant and connects the merchant website and the said mobile application via application programming interface (API). The said cache engine stores the e-commerce product catalog information into the mobile device and serves the product information from cache intelligently based on the frequent hit or reference by the mobile application users.

In one embodiment of the present invention, the said application deals with the mobile device internal cache engine of product catalog that fetches from the merchant website's catalog information system depending on the user traversing between two boundaries. The mobile user is browsing the products information in mobile device. The products are traversed in a sequential order while the customer browsing. The said cache engine stores the index of products and keep tracks of the traverse process using the index. When the traversing reaches the last 10^{th} product information of the product catalog in the cache storage, the said cache engine makes request to merchant's web server for the next set of 100 products. In order to accommodate the new set of product information the first received 100 products will be removed from cache. The new set of 100 product information will be appended to the said cache storage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

### ELITE MCOMMERCE—CACHE ENGINE—FIGURES

The FIG. 1 describes the high level flow of the Elite mCommerce Cache Engine's product navigation and information fetching process

The FIG. 2 of this document illustrates the detailed flow of the system that shows the display of product from the cache storage when the index is available in cache. If the index is not available then it will fetch the product information from the selected category indices or default category indices. The engine also fetches the product information as the user browses through the navigation based on their product index so that the product information is always available to show in the mobile device.

1. A method for creating cache to e-commerce application in mobile device comprising:
providing a cache in mobile devices by means of engine;
communicating with merchant website and mobile device database by means of application programming interface;
creating a cache of particular product information;
retrieving data from device database and from merchant website backend;
storing index of product information;
maintaining the track of traverse process using the said index; and
updating the required information periodically using merchant's website.

2. Method as claimed in claim 1, wherein retrieving information further comprises data of particular category, whereas the said data comprises information's such as product addition, stock information and price list.

3. Method as claimed in claim 1, wherein storing of data of said category in user device for future use by the said engine.

4. Method as claimed in claim 1, wherein importing data to the said application from the merchant website backend.

5. Method as claimed in claim 1, wherein refreshing the cache timely to meet the prefixed threshold range.

6. A cache storing application comprising:
an engine that stores product information in e-commerce application of user mobile device.
process the requests to fetch from cache first based on the user traversing product
if reaching boundary, process the cache refresh by requesting next set of product information
fetches product information from web server of an e-commerce application via application programming interface

7. Application as claimed in claim 6, wherein the said engine comprises one or more application programming interface.

8. Application as claimed in claim 6, wherein the said engine communicates with merchant website by means of application programming interface.

9. Application as claimed in claim 6, wherein the said engine creates a cache mechanism through application programming interface calls.

10. Application as claimed in claim 6, wherein the said engine functions with user's mobile device internal cache engine that fetches information from merchant website's catalog information system depending on the user traversing between two boundaries.

11. Application as claimed in claim 6, wherein no specific maintenance is required for the said application as the data in cache is updated periodically.

12. Application as claimed in claim 6, wherein the said engine induce the said application perform faster by storing the required data in device database.
